(19) United States
(12) Patent Application Publication
(10) Pub. No.: US 2025/0299097 A1
(43) Pub. Date: Sep. 25, 2025

(54) TIME-SERIES ANOMALY DETECTION

(71) Applicant: Analog Devices International Unlimited Company, Co. Limerick (IE)

(72) Inventor: Eoin Seamus Bolger, Co. Kilkenny (IE)

(21) Appl. No.: 18/862,810

(22) PCT Filed: Jun. 6, 2022
(86) PCT No.: PCT/EP2022/065301

§ 371 Date: Nov. 4, 2024

(30) Foreign Application Priority Data
May 6, 2022 (WO) PCT/EP2022/062366

(51) Int. Cl. G06N 20/00

(52) U.S. Cl. CPC G06N 20/00

(57) ABSTRACT

A first predictor trained on observations within a training window of a time-series signal is obtained. A confidence envelope for a prediction window of the time-series signal is estimated using the first predictor. An outlier portion is identified within the prediction window and a deviation point for the outlier portion is determined. The training window is moved such that the training window ends proximate the deviation point. A second predictor is trained on observations within the training window of the time-series signal that has been moved according to the update process

### FIELD OF INVENTION

The present disclosure relates to anomaly detection within time-series signals. Particularly, but not exclusively, the present disclosure relates to predictive confidence level based anomaly detection within time-series signals; more particularly, but not exclusively, the present disclosure relates to exploiting the deviation point of an anomalous portion of a time-series signal for predictive confidence level based anomaly detection within time-series signals.

### BACKGROUND

A time-series, or time-series signal, is a sequence of time-indexed observations obtained over a period, or interval, of time. The sequence of observations will typically relate to a single entity. For example, measurements periodically taken from a sensor over an interval of time form a time-series signal whereby each observation within the time-series signal corresponds to a measurement obtained from the sensor at a given time point.

Time-series analysis describes a suite of techniques for processing and analysing time-series signals. One aspect of time-series analysis is detecting anomalous signals or portions of a time-series signal. Often referred to as outliers, these anomalous signals represent noise or errors obtained during the recordal or transmission of a time-series signal. For example, a surge detected at a voltage sensor would appear as an outlier or anomaly within a time-series signal recorded from the voltage sensor. Removing such anomalies from a time-series signal may thus be an useful pre-processing step to help clean the time-series signal and ensure that only relevant observations are contained therein.

Predictive confidence level approaches to detecting anomalies within a time-series signal operate by training a predictive model on historical data to forecast future values. The confidence of the predictor at forecasting these future values is then utilised to detect potential anomalies. If anomalies are detected, then they are replaced by their corresponding predicted values. If no anomalies are detected, then the approach is repeated on the next time period or time window.

Therefore, existing approaches to time-series based anomaly detection are often slow and require a sliding window to be incrementally applied to a time-series signal to detect and replace anomalies. In addition, existing predictive confidence level approaches consider only the portion of the time-series signal which lies outside of a confidence interval as corresponding to an anomaly. This can result in discontinuities being introduced into the signal when replacing an anomalous portion lying outside the confidence level, particularly when the anomaly begins at a point prior to the first detected exceedance over the confidence interval. Moreover, many existing approaches to time-series anomaly detection are unable to identify anomalies accurately within non-stationary time-series signals (i.e., signals whose statistical properties vary over time).

### SUMMARY OF INVENTION

In the present disclosure, a first predictor, trained on observations within a training window of a time-series signal, is used to estimate a confidence envelope for a prediction window of the time-series signal. The training window is moved to end proximate the starting point of an outlier portion of the time-series signal identified within the prediction window. A second predictor is trained on observations within the moved training window.

The present disclosure provides a method and device for time-series based anomaly detection. A first predictor is obtained, the first predictor being trained on observations within a training window of a time-series signal. A confidence envelope is estimated, by the first predictor, for a prediction window of the time-series signal. The training window is then moved by determining if an outlier portion corresponding to a set of observations which lie outside of the confidence envelope exists within the prediction window, and if the outlier portion exists, moving the training window such that the training window ends proximate a deviation point determined for the outlier portion. A second predictor is trained on observations within the moved training window.

As such, aspects of the present disclosure allow accurate and efficient identification of anomalies within a time-series signal. This efficiency allows the method of the present disclosure to be deployed on edge devices where processing and memory resources are limited. Moreover, utilising the deviation point of an outlier portion of a time-series signal allows the outlier portion (i.e., the anomaly) to be more accurately identified and replaced, particularly when the outlier portion begins at a point prior to the signal exceeding the confidence interval. In many safety critical application areas (such as biomedical applications), this improved accuracy may help reduce false positives whereby anomalous portions of a signal may be incorrectly identified as important events (e.g., a rapid increase in heart rate or glucose level).

Further features and aspects of the disclosure are provided in the appended claims.

### BRIEF DESCRIPTION OF DRAWINGS

The present disclosure will now be described by way of example only with reference to the accompanying drawings in which:

FIG. 1 shows a plot of a time-series signal comprising an anomaly;

FIG. 2 shows a method for time-series based anomaly detection according to an aspect of the present disclosure;

FIG. 3 shows an update process performed at the moving step of FIG. 2 according to an aspect of the present disclosure;

FIG. 4 shows a time-series signal comprising an outlier portion having a deviation point;

FIGS. 5A and 5B show a time-series signal and a first predicted time-series signal with and without a discontinuity;

FIG. 6 shows a method for identifying a deviation point of an outlier portion according to an aspect of the present disclosure;

FIGS. 7A and 7B show a time-series signal and a transformed time-series signal determined as part of the deviation point identification method of FIG. 6;

FIG. 7 shows the transformed time-series signal of FIG. 6B with a threshold;

FIG. 8 shows a transformed signal and a threshold;

FIG. 9 illustrates different approaches for updating the training window and the prediction window;

FIG. 10 shows a predictor corresponding to a convolution neural network;

FIGS. 11A-C illustrate three approaches for cross validation when training a predictor;

FIGS. 12A and 12B show a device according to an aspect of the present disclosure; and

FIG. 13 shows an example computing system for time-series based anomaly detection according to an aspect of the present disclosure

### DETAILED DESCRIPTION

Many applications within the domain of signal processing and time-series analysis involve time-series signals with outlier or anomalous events. For example, time-series signals obtained from sensors may contain anomalous observations corresponding to inadvertent interaction with the sensor (e.g., the sensor being knocked or displaced) or anomalous increases or decreases in the process being sensed (e.g., a power surge). Other sources of such anomalous events include noise and sensor degradation due to age. Identifying and replacing such anomalous observations is an important pre-processing step within time-series applications. Specifically, in many application areas, identifying and removing anomalies helps improve control or operation of devices (e.g., biomedical devices such as dialysis machines or heart rate sensors) based on the processed time-series signal.

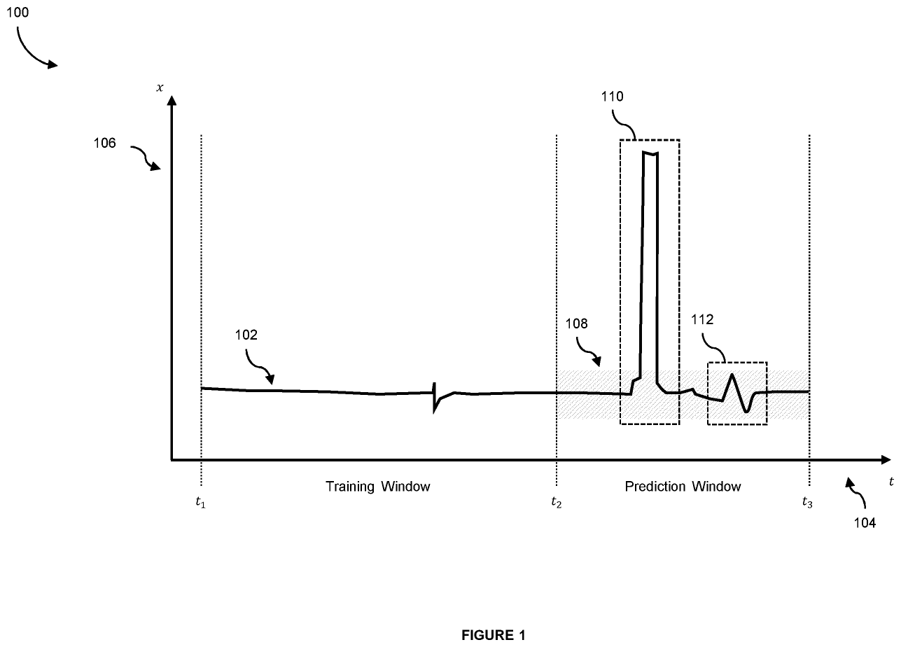

FIG. 1 shows a plot 100 of a time-series signal comprising an anomaly.

The plot 100 shows a time-series signal 102 plotted against a first axis 104 and a second axis 106. The first axis 104 corresponds to time, t, and the second axis 106 corresponds to an observation value or measurement (e.g., voltage, pulse rate, concentration level, etc.). The time-series signal 102 is shown plotted between time points t₁, t₂, and t₃. The window between time point t₁ and time point t₂ corresponds to a training window of the time-series signal 102. The window between time point t₂ and time point t₃ corresponds to a prediction window of the time-series signal 102. The plot 100 further shows, within the prediction window, a confidence envelope 108 for the prediction window, an outlier portion 110 of the time-series signal 102, and a non-outlier portion 112 of the time-series signal 102.

A time-series based predictor may be used to detect the presence of the outlier portion 110, alternatively referred to as an outlier, anomaly, or anomalous portion, within the time-series signal 102. Specifically, a time-series predictor, such as an autoregressive integrated moving average (ARIMA) model, may be trained on the observations within the training window. Once trained, the time-series predictor forecasts, or estimates, an observation value at a time point t+1 based on a previous window of observations (e.g., observations at time points t, t−1, . . . , t−n). Alternatively, the time-series predictor forecasts a plurality of observation values at future time points (e.g., time points t+1, . . . , t+m) based on the previous window of observations. In the example shown in the plot 100, the time-series predictor forecasts predicted observations, or predictions, for all time points within the prediction window t₂ to t₃.

The confidence envelope 108 may be calculated from the error rate of the predictor and corresponds to the uncertainty that the predictor has in relation to the predictions produced within the prediction window. The confidence envelope 108 comprises an upper envelope corresponding to the upper region, or threshold, of the confidence envelope 108, and a lower envelope corresponding to the lower region, or threshold, of the confidence envelope 108. In some examples, the confidence envelope corresponds to a confidence interval having a fixed upper and lower envelope across the prediction window (as illustrated by the confidence envelope 108 of FIG. 1). In alternative examples, the confidence envelope corresponds to a confidence band having upper and lower envelopes which vary across the prediction window.

Confidence level anomaly detection techniques utilize confidence envelopes to detect outliers within a time-series signal. In the example shown in the plot 100, the time-series signal 102 may be compared to the confidence envelope 108 to identify the outlier portion 110 of the time-series signal 102 which lies outside the confidence envelope 108. The outlier portion 110 is considered to be an outlier because it comprises a plurality of observations which lie outside of the observed error margins, or uncertainty, of the predictor. In contrast, the non-outlier portion 112 shown in the plot 100 comprises a high-level of variability (e.g., due to noise) but lies within the confidence envelope 108, and thus within the observed error margins of the predictor.

Once detected, the outlier observations, i.e., the observations within the outlier portion 110 which lie outside of the confidence envelope 108, may be replaced by predicted observations determined by the predictor.

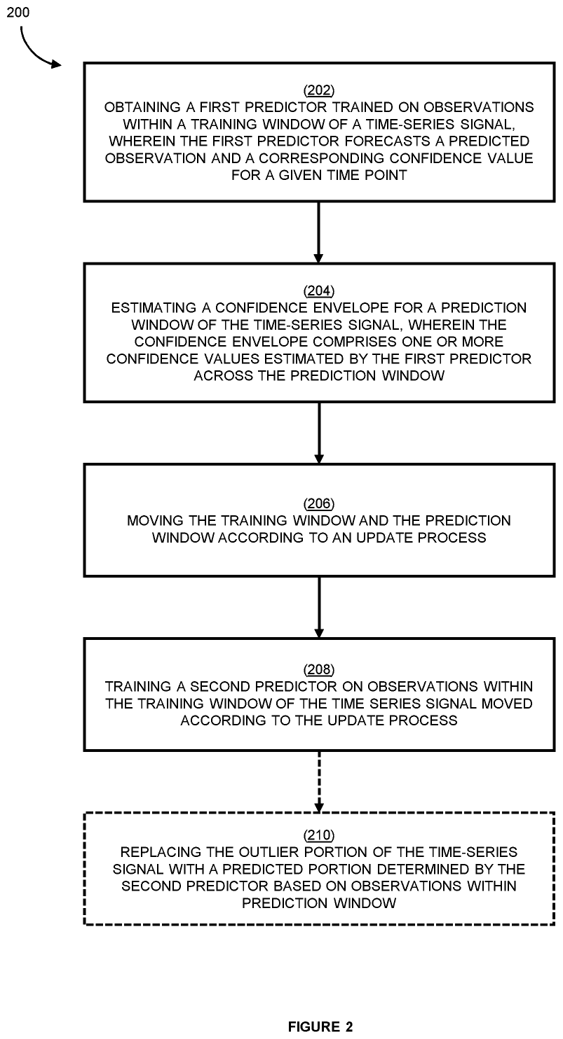

As stated above, existing predictive confidence level approaches to time-series based anomaly detection, such as that described in relation to FIG. 1, are often slow and require a sliding window to be incrementally applied to a time-series signal to detect and replace anomalies. For example, after performing anomaly detection at time points t₁, t₂, and t₃, the process is repeated at time points t₁+1, t₂+1, and t₃+1. Moreover, existing approaches are unable to identify anomalies accurately within non-stationary time-series signals and when the anomaly starts at a point prior to the time-series signal exceeds the confidence envelope. Some if not all of these issues are addressed by the methods of the present disclosure, as shown in FIG. 2.

FIG. 2 shows a method 200 for time-series based anomaly detection according to an aspect of the present disclosure.

The method 200 comprises the steps of obtaining 202 a first predictor, estimating 204 a confidence envelope, moving 206 a training window and a prediction window according to an update process, and training 208 a second predictor. The method 200 optionally comprises the step of replacing 210 an outlier portion.

At the step of obtaining 202, a first predictor trained on observations within a training window of a time-series signal is obtained. The first predictor forecasts a predicted observation and a corresponding confidence value for a given time point.

The training window comprises a plurality of observations of the time-series signal upon which the first predictor has been, or is, trained. In one example, the size of the training window is set to a predetermined length of time (e.g., 100 time steps, 200 time steps, etc.). The size of the training window is chosen so as to include sufficient training observations to robustly train the first predictor. In a further example, the size of the training window is set as 3 minutes.

The first predictor corresponds to any suitable time-series based prediction model. In one example, the first predictor corresponds to a moving average prediction model. A moving average model calculates a predicted observation, \hat{x}ₜ₊₁ at time point t based the average of all observations in a window t−k, . . . , t−1 such that \hat{x}ₜ=1/kΣᵢ₌₁^{k}yₜ₋ᵢ. The moving average model fails to capture anomalies with a gradual change, or an initial gradual change, and will often introduce a lag or delay in the detection of an anomaly—i.e., the anomaly is detected at a point in time after the anomaly occurs in the time-series signal. An alternative to the moving average model is the weighted average, where a weight vector, ω, is used to assign greater importance to more recent observations. In such a model, the predicted observation is determined as \hat{x}ₜ=Σᵢ₌₁^{k}ωᵢyₜ₊₁₋ᵢ where Σω=1.

In an alternative example, the first predictor corresponds to an autoregressive integrated moving average (ARIMA) model. Alternatively, the first predictor corresponds to a linear regression model. In a further alternative, the first predictor corresponds to an artificial neural network or deep learning model. Examples of such models include long short-term memory (LSTM) networks, gated recurrent units (GRU), convolutional neural networks (CNNs), and the like.

Referring once again to FIG. 1, the first predictor is trained on the observations of the time-series signal 102 which lie within the training window. That is, the predictor is trained on all observations between time point t₁ and time point t₂. In some examples, obtaining the first predictor comprises training the first predictor. As such, the method 200 optionally comprises, as part of the step of obtaining 202, training the first predictor on observations within the training window of the time series signal. Further details regarding training a predictor are given in relation to the second predictor, as described in detail below.

The trained predictor forecasts, or predicts, an observation and a corresponding confidence value for a given time point. Alternatively, the predictor may forecast, or predict, a plurality of observations and a corresponding plurality of confidence values for a plurality of future time points.

For frequentist predictors, such as moving average predictors or ARIMA, the confidence value corresponds to a global error rate of the predictor. As such, the confidence value is for all predicted observations obtained from the predictor trained on observations within the training window. For Bayesian predictors, such as sequential Monte Carlo models or deep learning models incorporating dropout (as described below), the confidence value corresponds to the uncertainty associated with the corresponding prediction. As such, the confidence values vary across the predictions.

The confidence values determined from the first predictor are used to estimate a confidence envelope across the prediction window.

Referring once again to FIG. 2, the method 200 further comprises estimating 204 a confidence envelope for a prediction window of the time-series signal, wherein the confidence envelope comprises one or more confidence values estimated by the first predictor across the prediction window.

The prediction window corresponds to a period of time, which is disjoint to, and preferably after, the training window, within which a confidence envelope is estimated. The size of the prediction window is preferably less than the size of the training window. In one example, the ratio of the size of the training window to the size of the prediction window is 5:1 or 4:1 and most preferably is 3:1. In a specific example, when the size of the training window is 3 minutes, the size of the prediction window is at least 40 seconds and at most 1 minute.

For frequentist predictors, a global error rate of the first predictor is used to determine the confidence envelope across all time steps in the prediction window. Consequently, the confidence envelope may be defined by a confidence value corresponding to the global error rate of the first predictor. The confidence envelope thus comprises an upper envelope, or upper portion, corresponding to the global error rate of the first predictor added to the average value of the time-series signal within the prediction window. The confidence envelope further comprises a lower envelope, or lower portion, corresponding to the global error rate of the first predictor subtracted from the average value of the time-series signal within the prediction window.

For Bayesian predictors, the confidence envelope corresponds to a confidence band such that the confidence values vary for each time point within the prediction window. As described in more detail below, the value of the confidence band is estimated at a given time point within the prediction window based on the uncertainty associated with a forecast produced for the given time point by the first predictor.

The confidence envelope 108 shown in FIG. 1 corresponds to a confidence interval estimated by a predictor across the prediction window from time point t₂ to time point t₃. The confidence envelope 108 captures the uncertainty, or error bounds, of the predictor trained on observations within the training window from time point t₁ to time point t₃. AS such, the confidence envelope 108 captures the bounds within which the time-series signal 102 is expected to lie. Consequently, an observation which lies outside of these bounds will likely correspond to an outlier.

A confidence envelope calculated across the prediction window, such as the confidence envelope 108 of FIG. 1, is thus used to determine whether the portion of the time-series signal within the prediction window comprises an outlier portion, such as outlier portion 110 of FIG. 1. Once an outlier portion has been detected (or not), the training window and the prediction window are moved to continue anomaly detection on a subsequent portion of the time-series signal.

Referring once again to FIG. 2, the method 200 further comprises moving 206 the training window according to an update process.

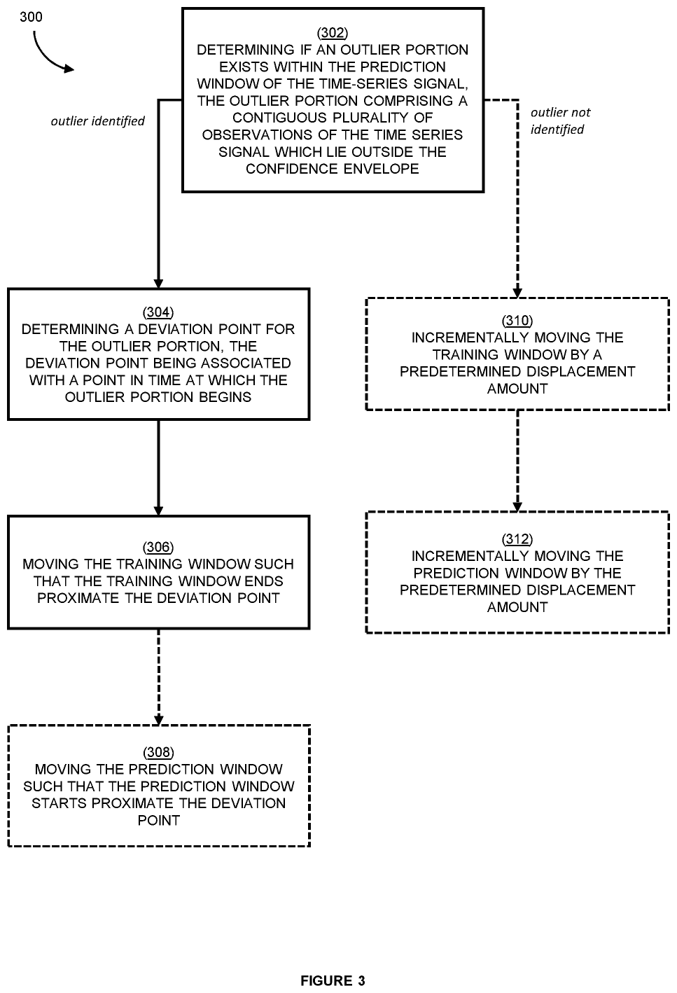

FIG. 3 shows an update process 300, such as that performed at the step of moving 206 of FIG. 2, according to an aspect of the present disclosure.

The update process 300 comprises the steps of determining 302 if an outlier portion exists, determining 304 a deviation point, and moving 306 the training window. The update process 300 optionally comprises the steps of moving 308 the prediction window, incrementally moving 310 the training window, and incrementally moving 312 the prediction window.

Beneficially, the update process 300 shown in FIG. 3 efficiently detects anomalies within the time-series signal whilst also allowing accurate replacement of anomalous portions of the time-series signal.

The update process 300 comprises the step of determining 302 if an outlier portion exists within the prediction window of the time-series signal, the outlier portion comprising a contiguous plurality of observations of the time-series signal which lie outside the confidence envelope.

If the outlier portion is determined to exist within the prediction window (i.e., there exists a contiguous plurality of observations of the time-series signal which lie outside the confidence envelope), then the update process 300 proceeds to the step of determining 304 a deviation point. Here a contiguous plurality of observations which lie outside the confidence envelope corresponds to a plurality of sequential observations which are temporally consecutive, and all lie outside of the confidence envelope. Alternatively, the update process 300 proceeds to the step of determining 304 a deviation point if a single observation of the time-series signal lies outside the confidence envelope. Here, an observation is considered to lie outside of the confidence envelope if it has a value (observation value) that is greater than the confidence envelope (i.e., greater than the upper envelope of the confidence envelope at the time point associated with the observation) or less than the confidence envelope (i.e., less than the lower envelope of the confidence envelope at the time point associated with the observation).

Optionally, if the outlier portion is determined not to exist within the prediction window (i.e., if the time-series signal lies entirely within the confidence envelope), then the update process proceeds to the step of incrementally moving 310 the training window and subsequently incrementally moving 312 the prediction window. In both instances, the training window and the prediction window are incrementally moved by a predetermined displacement amount such as 1 time step, 2 time steps, 3 time steps and the like. The skilled person will appreciate that the predetermined displacement amount should be sufficiently small such that portions of the time-series signal are skipped and thus missed from processing.

As such, in some examples the step of determining 302 if the outlier portion exists within the prediction window comprises the step of comparing the time-series signal to the confidence envelope such that an outlier portion is determined to exist when a portion of the time-series signal within the prediction window lies outside the confidence envelope. Similarly, in some examples the optional steps of incrementally moving 310 the training window and incrementally moving 312 the prediction window are performed when the time-series signal within the prediction window lies inside the confidence envelope (based on the comparing).

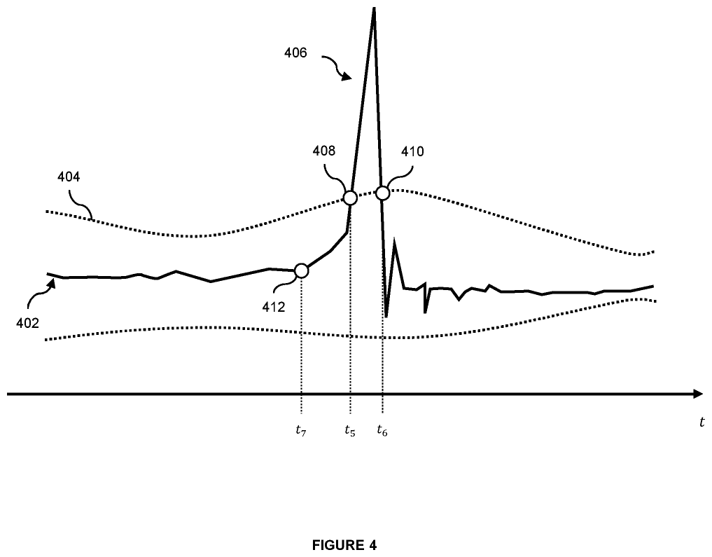

If an outlier portion is identified within the prediction window, then the update process 300 moves the training window to a point in time corresponding to the start of the outlier portion, otherwise referred to as the deviation point. This is illustrated in FIG. 4.

FIG. 4 shows a time-series signal 402 comprising an outlier portion having a deviation point.

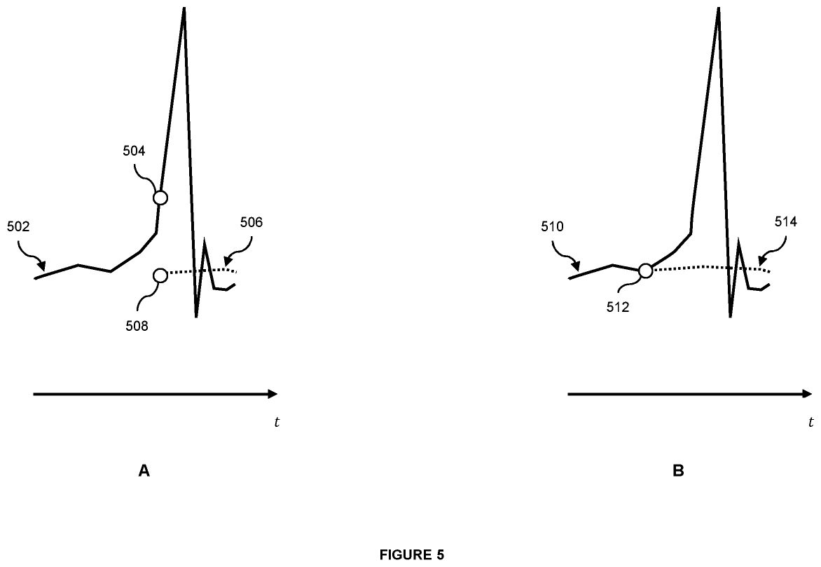

FIG. 4 shows the time-series signal 402 and a confidence band 404. An outlier portion 406 of the time-series signal 402 corresponds to a contiguous plurality of observations of the time-series signal 402 which lie outside the confidence band 404. Specifically, the outlier portion 406 corresponds to the plurality of observations of the time-series signal 402 between a first point 408 and a second point 410. A deviation point 412 corresponds to the time at which the outlier portion 406 begins. That is, whilst the outlier portion 406 is identifiable from the observations of the time-series signal 402 which lie outside of the confidence band 404, the outlier portion 406 captures an underlying anomaly which begins at a point prior to the time at which the time-series signal 402 crosses the confidence band 404. This can be seen from the portion of the time-series signal 402 between the deviation point 412 and the first point 408. Consequently, limiting the anomaly to the portion of the time-series signal 402 occurring between the first point 408 and the second point 410 does not adequately capture the full characteristic of the anomaly. This may introduce errors or discontinuities in the replacement portion of the time-series signal as illustrated in FIG. 5A.

FIG. 5A shows a time-series signal 502 and a first predicted time-series signal having a discontinuity.

The time-series signal 502 corresponds to a portion of the time-series signal 402 shown in FIG. 4. The time-series signal 502 is shown up to the first point 504 which corresponds to the first point 408 shown in FIG. 4. A first predicted time-series signal 506 is shown beginning at a starting point 508 which corresponds in time to the first point 504. The first predicted time-series signal 506 corresponds to a time-series signal obtained from a predictor trained on a training window terminating at the first point 504. The prediction window begins at the first point 504. As shown, there is a discontinuity between the time-series signal 502 which terminates at the first point 504 and the first predicted time-series signal 506 which begins at the starting point 508.

In contrast, the present disclosure exploits the deviation point of the outlier portion to overcome the above problems with signal discontinuity. This is illustrated in FIG. 5B.

FIG. 5B shows a time-series signal 510 and a second predicted time-series signal without a discontinuity.

The time-series signal 510 corresponds to a portion of the time-series signal 402 shown in FIG. 4 which is the same as the portion of the time-series signal 502 shown in FIG. 5A. The time-series signal 510 is shown up to a deviation point 512 which corresponds to the deviation point 412 shown in FIG. 4. A second predicted time-series signal 514 is shown beginning at the deviation point 512. The second predicted time-series signal 514 corresponds to a time-series signal obtained from a predictor trained on a training window terminating at the deviation point 512. Consequently, the prediction window begins at the deviation point 512. Because the outlier portion is fully contained within the prediction window, the replacement of the outlier portion of the time-series signal with the second predicted time-series signal 514 does not introduce a discontinuity. As such, identifying the deviation point of the outlier portion allows a more accurate process for filtering the anomaly within the time-series signal.

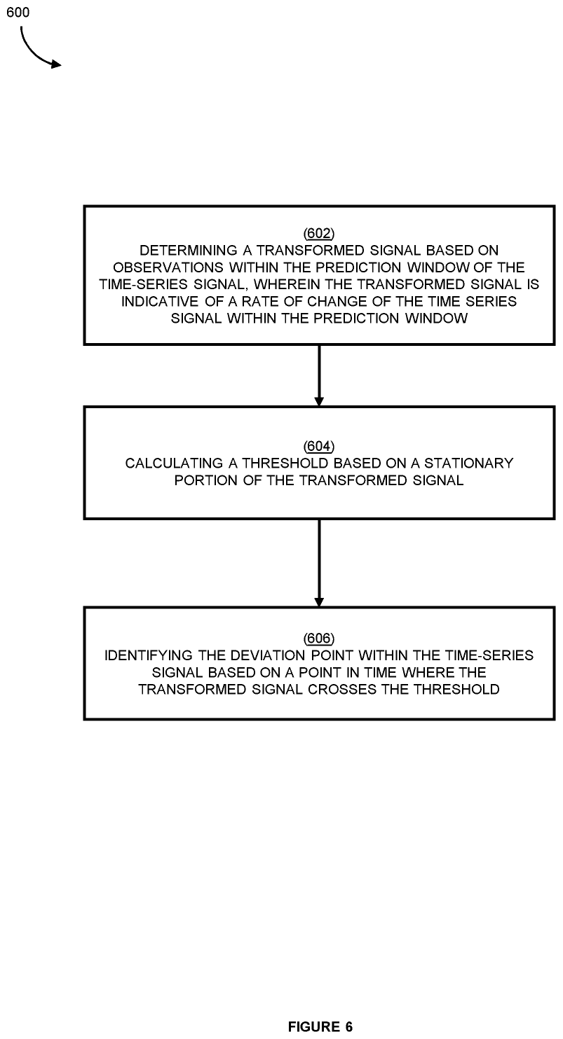

FIG. 6 shows a method 600 for identifying a deviation point of an outlier portion according to an aspect of the present disclosure.

The method 600 comprises the steps of determining 602 a transformed signal, calculating 604 a threshold, and identifying 606 the deviation point.

The method 600 comprises the step of determining 602 a transformed signal based on observations within the prediction window of the time-series signal, wherein the transformed signal is indicative of a rate of change of the time-series signal within the prediction window.

The transformed signal is determined from the time-series signal. Consequently, the time-series signal and the transformed signal are temporally aligned such that both signals span the same time window. As will be described in more detail below, the transformed signal is utilised to identify the point in time in which the outlier portion starts (i.e. the deviation point) within the time-series signal.

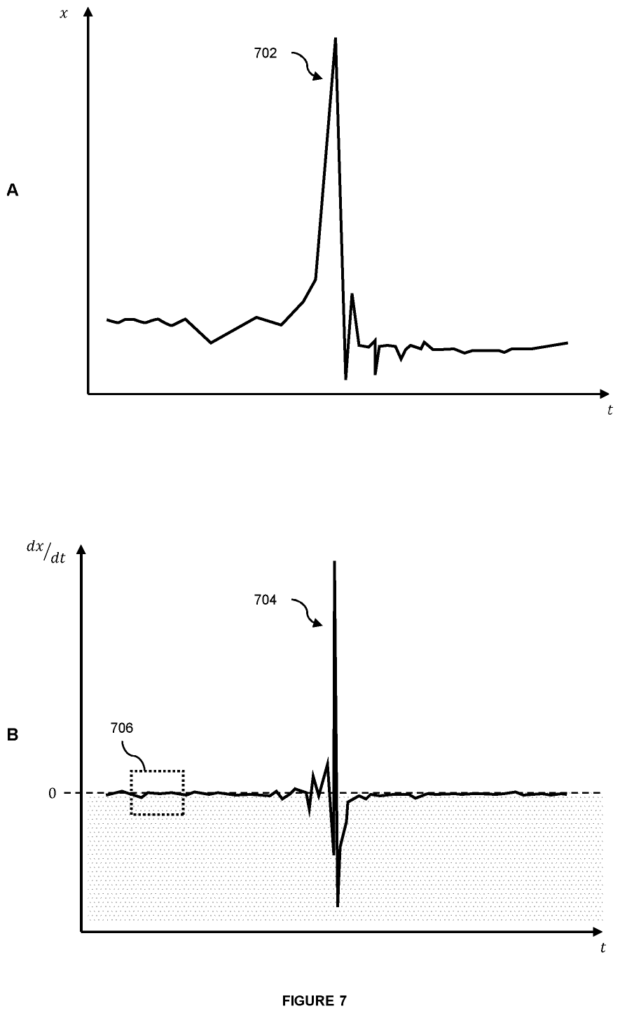

The transformed signal is a transformation of the time-series signal that captures the rate of change, or acceleration, of the time-series signal. This is illustrated in FIGS. 7A and 7B.

FIG. 7A shows a time-series signal 702 and FIG. 7B shows a transformed signal 704. FIG. 7B further shows a stationary portion 706 of the transformed signal 704. The time-series signal 702 corresponds to the time-series signal 402 shown in FIG. 4.

Whilst the present description relates to determining the deviation point from the entirety of the prediction window, the skilled person will appreciate that a sub-window thereof may also be used to identify the deviation point. For example, a window of a fixed size around the portion of the time-series signal which lies outside of the confidence envelope can be used to identify the deviation point. Thus, the present disclosure is not limited to estimating the deviation point using the entire prediction window.

The transformed signal 704 is determined from the time-series signal 702. Consequently, the time-series signal 702 and the transformed signal 704 are temporally aligned such that both signals span the same time window. The transformed signal 704 is a transformation of the time-series signal 702 that captures the rate of change, or acceleration, of the time-series signal 702. As such, the transformed signal 704 corresponds to a derivative of the time-series signal 702. In the example shown in FIG. 7B, the transformed signal 704 corresponds to the first derivative of the time-series signal 702. However, higher-order derivatives, such as the second order derivative, third order derivative, and the like, may additionally or alternatively be used to obtain the transformed signal from the time-series signal.

The first derivative of the time-series signal may be calculated using a finite difference method. As is known, the finite difference method is used to approximate the derivative of a function from a set of data points when the exact formula for the function is not known. The finite difference method can also be used to calculate higher order derivatives such as the second derivative, third derivative, and the like. Alternatively, the first derivative may be calculated using symbolic differentiation, automatic differentiation, and the like.

Referring once again to FIG. 6, the method 600 further comprises calculating 604 a threshold based on a stationary portion of the transformed signal.

Although the transformed signal is generally non-stationary, portions of the transformed signal will be substantially stationary; that is, the statistical properties of the portion of the transformed signal will be relatively constant over time. The stationary portion of the transformed signal corresponds to any portion of the transformed signal which does not contain an outlier or anomaly.

As shown in FIG. 7B, the stationary portion 706 of the transformed signal 704 is stationary because the statistical properties of the observations within the stationary portion 706 are largely constant over time.

The stationary portion of the transformed signal has a length such that the stationary portion contains a set number of data points. Selecting the set number of data points to include within the stationary portion therefore determines the predetermined length. Preferably, the set number of data points is greater than or equal to 10, and more preferably is greater than or equal to 20. More preferably still, the set number of data points is greater than 30 but less than 100 and more preferably still is equal to 50. The stationary portion can then be identified using a sliding window approach whereby a window of the predetermined length (as described above) is placed over an initial portion of the transformed signal. If the data points within the window satisfy a stationarity criterion, then the portion is identified as the stationary portion. An example stationarity criterion is based on the mean and variance of sections of data within the window. The data points within the window may be split into sets (e.g. 2 sets, 4 sets, or 8 sets, etc.) and the mean and variance of the data points within each section may be calculated. The stationarity criterion may be met if the mean and variance across all sets is substantially the same, i.e. any change in the mean and variance is less than a predetermined, small, threshold value. If the stationarity criterion is not met, then the window is moved to a new position along the transformed signal. For example, the starting point of the window is incremented by a predetermined amount. The above process is then repeated until the stationarity criteria is met.

Alternatively, the stationary portion can be adaptively determined by identifying a starting point within the transformed signal (e.g. the first data point within the transformed signal) and iteratively increasing the number of data points to include within the stationary portion that are proximate the starting point. For example, the first iteration includes the first five data points, the second iteration includes the first six data points, the third iteration includes the first seven data points, and so on. A statistical measure is taken over all points within the stationary portion at each iteration. Example statistical measures include the mean value of all data points, the standard deviation, and the like. The iteration is terminated, and thus the identification of the stationary portion complete, once the statistical measure meets a termination criteria. For example, the termination criteria may be met when the difference between the statistical measure recorded across consecutive iterations is approximately zero.

The stationary portion 706 is used to identify a threshold, or envelope. Generally, an envelope of a time-series signal corresponds to the boundary within which the time-series signal is substantially contained. The envelope of a time-series signal therefore includes an upper envelope, or upper threshold, and a lower envelope, or lower threshold. The upper threshold corresponds to a sequence of data points, or a curve, outlining the upper extreme of the signal, whilst the lower threshold corresponds to a sequence of data points, or a curve, outlining the lower extreme of the signal.

The envelope of the observations within the stationary portion 706 is based on a standard deviation calculated from observations within the stationary portion 706. Optionally, a moving average and moving standard deviation can be utilised to determine the envelope. In an alternative example, the envelope corresponds to a Bollinger-Band.

The threshold calculated at the step of calculating 604 in the method 600 (see FIG. 6) corresponds to the upper envelope, or upper threshold, of the envelope calculated for the observations within the stationary portion 706. Although the threshold is determined using only a portion of the transformed signal—e.g. the observations of the transformed signal 704 within the stationary portion 706—the threshold is defined across the entire prediction window. The threshold is extended across the prediction window by setting the maximum value of the upper envelope as a scalar threshold. Alternatively, the threshold is extended across the prediction window by setting a given value (e.g., the average value, minimum value, starting value, ending value, etc.) of the upper envelope as a scalar threshold.

Once the threshold has been determined, it is used to identify the deviation point within the time-series signal.

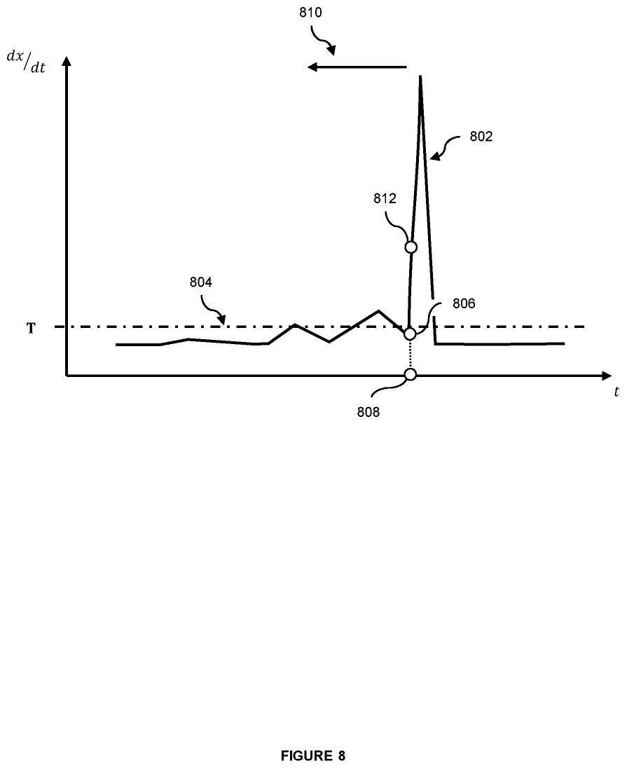

Referring once again to FIG. 6, the method 600 further comprises identifying 606 the deviation point within the first signal based on a point in time where the transformed signal crosses the threshold. This is illustrated in FIG. 8.

FIG. 8 shows a transformed signal 802 and a threshold 804 (as calculated above).

The transformed signal 802 has a deviation point 806 at a time point 808. FIG. 8 further shows a reverse temporal direction 810 and a value 812. The transformed signal 802 corresponds to a processed form of the transformed signal 704 shown in FIG. 7B. The transformed signal 802 has been processed such that all negative observations have been zeroed.

The deviation point 806 is associated with the time point 808 where the transformed signal 802 crosses the threshold 804. In one example, the deviation point 806 within the transformed signal 802 is identified by iterating along the transformed signal 802 in the reverse temporal direction 810 to identify the time point 808 where the transformed signal 802 crosses the threshold 804 (i.e. is below the threshold 804). The traversal begins at the value 812 which corresponds to a time point equal to the point in time at which the time-series signal crosses the confidence envelope. Thus, the value 812 is at a time point corresponding to the time point associated with the first point 408 of the time-series signal 402 shown in FIG. 4.

Given that the transformed signal 802 may cross the threshold 804 multiple times, the deviation point 806 within the transformed signal 802 is identified based on the time point 808 where the transformed signal 802 crosses the threshold 804 proximate the value 812. Put another way, the deviation point 806 corresponds to a crossing of the transformed signal 802 and the threshold 804 which is temporally closest to the value 812.

As an alternative to the above iterative approach, the deviation point is identified using a piecewise operation. If the transformed signal 802 is represented by a one-dimensional vector, then a piecewise operation can be applied to the vector to identify only those values which are below the threshold 804. For example, all values of the one-dimensional vector which are not less than the threshold 804 can be zeroed. The deviation point 806 within the transformed signal 802 is then identified as the temporally closest non-zero value to time point associated with the value 812 in the reverse temporal direction 810.

Whilst the above description relates to identifying the deviation point 806 within the transformed signal 802, the deviation point within the original time-series signal (e.g., the time-series signal 702 shown in FIG. 7) is identified as the data point within the time-series signal having a time value equal to the time point 808.

Beneficially, the deviation point detection process described above provides an accurate and efficient mechanism for identifying the start of the outlier portion. This not only allows the outlier portion to be more accurately replaced, but also facilitates a more efficient outlier replacement strategy by increasing the step at which the training window and prediction window can be moved (as described below).

Referring once again to FIG. 3, after the step of determining 304 the deviation point for the outlier portion, the update process 300 comprises the step of moving 306 the training window such that the training window ends proximate the deviation point.

The step of moving 306 the training window comprises translating the training window along the time dimension such that the training window ends proximate the deviation point. Here, proximate the deviation point is to be understood as being near to the deviation point. Preferably, the training window is moved so that the training window ends at the deviation point. Alternatively, the training window is moved so that it ends within a predetermined distance to the deviation point. In one example implementation, the predetermined distance is calculated as a percentage of the size (or length) of the prediction window such that the predetermined distance is 50% of the size of the prediction window or between 25-50% of the size of the prediction window.

Optionally, the update process 300 further comprises the step of moving 308 the prediction window such that the prediction window starts proximate the deviation point. Here, proximate the deviation point is to be understood as being near to the deviation point. Preferably, the prediction window is moved so that the prediction window starts at the deviation point. Alternatively, the prediction window is moved so that it starts within a predetermined distance to the deviation point. In one example implementation, the predetermined distance is calculated as a percentage of the size (or length) of the prediction window as described above.

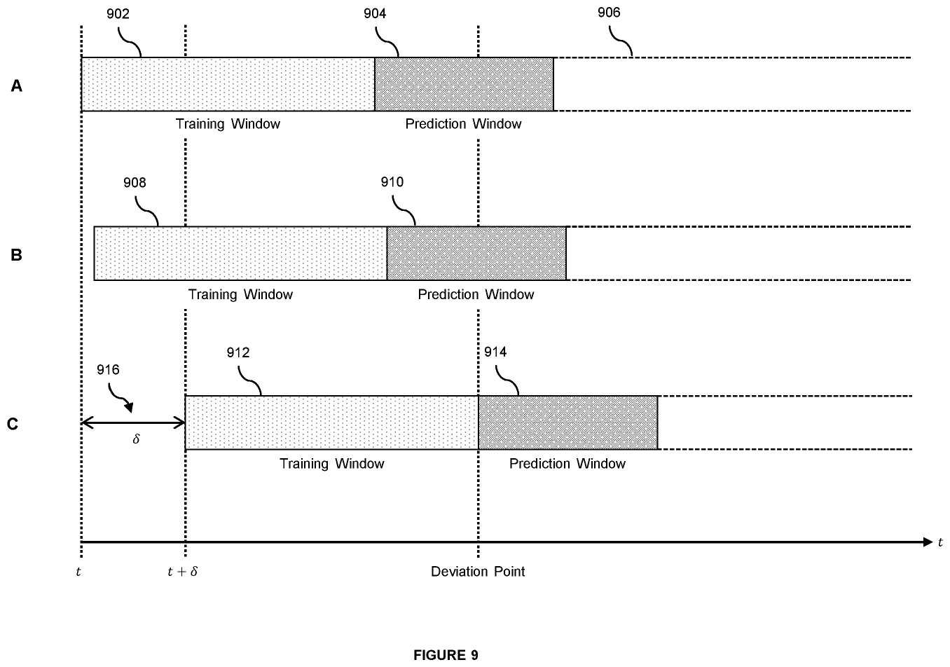

As stated above, by moving the training window and prediction window to be proximate the deviation point of the outlier portion, the windows can be moved by a greater amount than if the windows were moved by a predetermined incremental account. This allows the anomaly detection method to move through the time-series signal in a faster and more efficient manner. This is illustrated in FIG. 9.

FIG. 9 illustrates different approaches for updating the training window and the prediction window.

FIG. 9A illustrates a first training window 902 of a time-series signal (not shown), a first prediction window 904 of the time-series signal, and an unused portion 906 of the time-series signal. FIG. 9A represents a training window and a prediction window which are to be updated (i.e., moved) as shown in FIGS. 9B and 9C.

FIG. 9B illustrates a second training window 908 of the time-series signal and a second prediction window 910 of the time-series signal. The second training window 908 corresponds to the first training window 902 temporally shifted by a predetermined amount. The second prediction window 910 corresponds to the first prediction window 904 temporally shifted by the same predetermined amount as the first training window 902.

FIG. 9C illustrates a third training window 912 of the time-series signal and a third prediction window 914 of the time-series signal. The third training window 912 corresponds to the first training window 902 temporally shifted by an amount 916 so that the third training window 912 ends proximate the deviation point. The third prediction window 914 corresponds to the first prediction window 904 temporally shifted by the amount 916 so that the third prediction window 914 starts proximate the deviation point.

As can be seen, by shifting the training window and the prediction window to be proximate the deviation point (FIG. 9C), the training window and the prediction window can be moved by a greater amount than when moving according to a predetermined amount (FIG. 9B).

Referring once again to FIG. 2, after the update process has been performed, the method 200 further comprises the step of training 208 a second predictor on observations within the training window of the time-series signal that has been moved according to the update process.

The step of training 208 a second predictor comprises training a suitable predictor using the observations within the updated training window. Alternatively, the step of training a second predictor comprises retraining the first predictor on observations within the second training window.

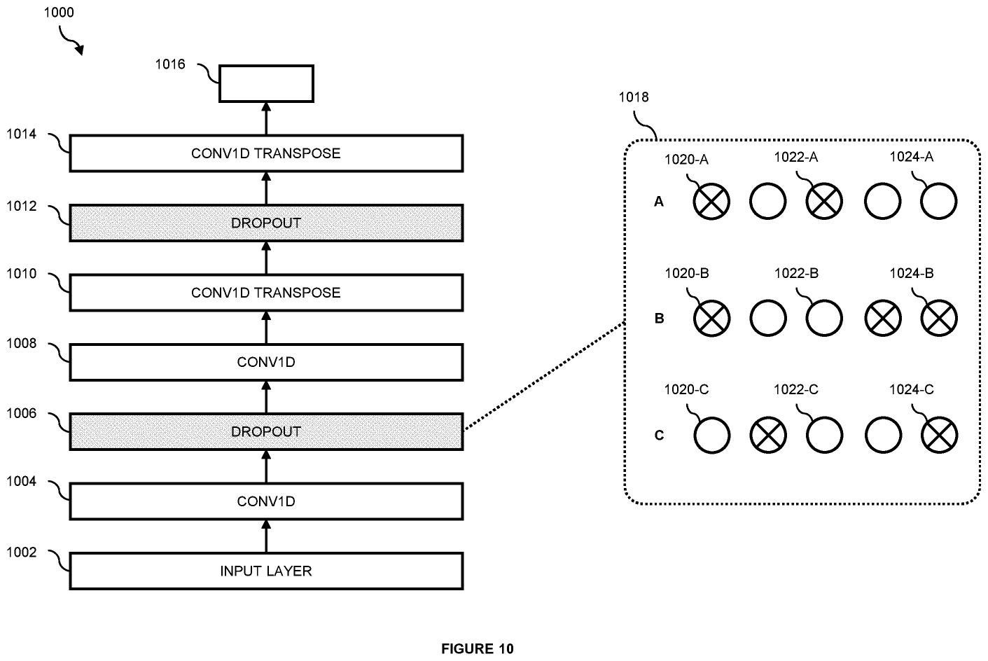

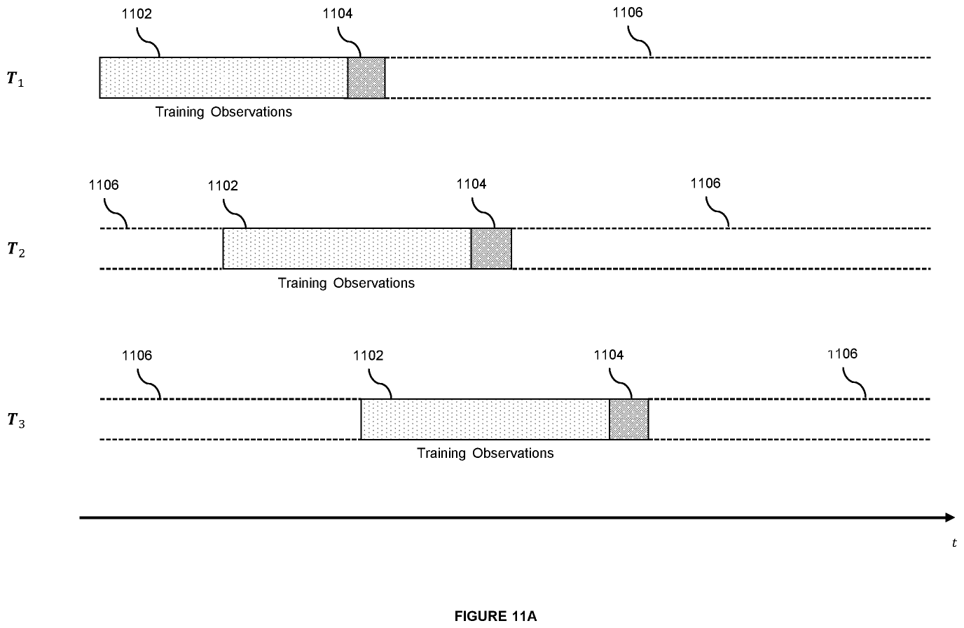

As stated above in relation to the first predictor, the second predictor corresponds to any suitable time-series based prediction model such as a weighted average model, ARIMA model, and the like. In one example, the second predictor comprises a deep learning model and more particularly a convolutional neural network. The deep learning model or the convolutional neural network may comprise at least one dropout layer such that the second predictor may be used as a Bayesian predictor. An example of such a model is illustrated in FIG. 10.

FIG. 10 shows a predictor corresponding to a convolution neural network 1000.

The convolutional neural network 1000 comprises an input layer 1002, a first 1D convolution layer 1004, a first dropout layer 1006, a second 1D convolution layer 1008, a first transposed convolution layer 1010, a second dropout layer 1012, and a second transposed convolution layer 1014. The second transposed convolution layer 1014 outputs an output value 1016. FIG. 10 further shows a dropout process 1018 performed at the first dropout layer 1006. The dropout process 1018 shows the states (A, B, C) of a first unit 1020, a second unit 1022, and a third unit 1024 of the first dropout layer 1006.

In some examples, the first predictor and/or the second predictor correspond to the convolutional neural network 1000 shown in FIG. 10.

The input layer 1002 comprises a number of units corresponding to the number of observations to use. For example, the input layer 1002 may comprise 260 units corresponding to 260 observations which, when sampled at 250 ms, is approximately equal to 3 minutes of historical data The first 1D convolution layer 1004 corresponds to a hidden layer with 32 filters, a convolution window size (i.e., kernel size) of 7, and a stride length of 2. The first dropout layer 1006 has a dropout rate of 0.2 and is described in more detail below. The second 1D convolution layer 1008 corresponds to a hidden layer with 16 filters, a kernel size of 7, and a stride length of 2. The first transposed convolution layer 1010 corresponds to a hidden layer with 16 filters, a kernel size of 7, and a stride length of 1. The second dropout layer 1012 has a dropout rate of 0.2. The second transposed convolution layer 1014 has 1 filter, a kernel size of 7, and uses even zero-padding. The first 1D convolution layer 1004, the second 1D convolution layer 1008, and the first transposed convolution layer 1010 use even zero-padding (i.e., the input is padded evenly with zeros such that the output has the same dimension as the input) and a relu activation function.

Dropout layers, such as the first dropout layer 1006 and the second dropout layer 1012, randomly deactivate units within a layer of a neural network. When used during training, dropout helps prevent overfitting. However, dropout may also be used during prediction (i.e., after the neural network has been changed) to obtain multiple predictions from the space of all available models. That is, the use of dropout can be interpreted as a Bayesian approximation of a Gaussian process. Each time dropout is applied, different units are dropped out resulting in slightly different networks being obtained. The predictions obtained from the different networks can be treated as Monte Carlo samples from the space of all available networks (i.e., all available models). This allows an approximation of the model's uncertainty to be obtained for a prediction. This is illustrated in the dropout process 1018 shown in FIG. 10.

Once the convolutional neural network 1000 is trained, the first dropout layer 1006 and the second dropout layer 1012 randomly set inputs received from the first 1D convolution layer 1004 and the first transposed convolution layer 1010 to zero each time a prediction is obtained from the convolutional neural network 1000. When obtaining a first prediction, the first dropout layer 1006 is in a first state “A” such that the first unit 1020-A and the second unit 1022-A are set to zero whilst the third unit 1024-A is left unchanged (although a scaling operation is typically applied to ensure that the sum over all inputs remains unchanged during the dropout process). When obtaining a second prediction, the first dropout layer is in a second state “B” such that the first unit 1020-B and the third unit 1024-B are set to zero whilst the second unit 1022-B is left unchanged. When obtaining a third prediction, the first dropout layer 1006 is in a third state “C” such that only the third unit 1024-C is set to zero whilst the first unit 1020-C and the second unit 1022-C are left unchanged. Because each prediction involves different units the predictions will differ.

Obtaining multiple predictions thus allows a confidence band to be obtained from the multiple predictions since the convolutional neural network 1000 operates as a Bayesian predictor. The confidence band thus corresponds to a Bayesian approximation of uncertainty associated with predictions produced by the deep learning model (e.g., by the convolution neural network 1000) based on observations within the prediction window of the time-series signal.

Referring once again to FIG. 2, the second predictor is trained at the step of training 208 on observations within the training window of the time-series signal that has been moved according to the update process.

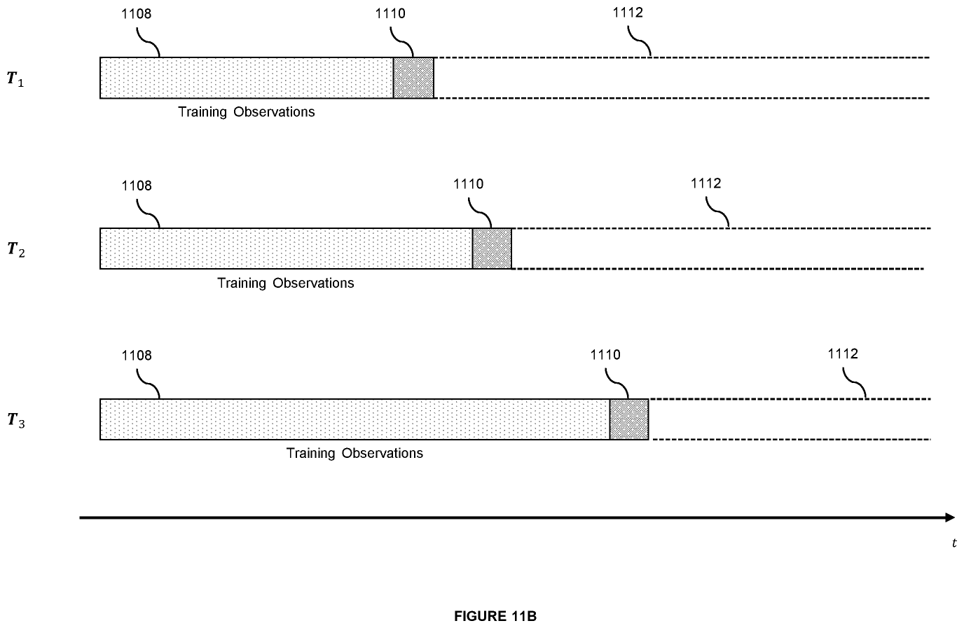

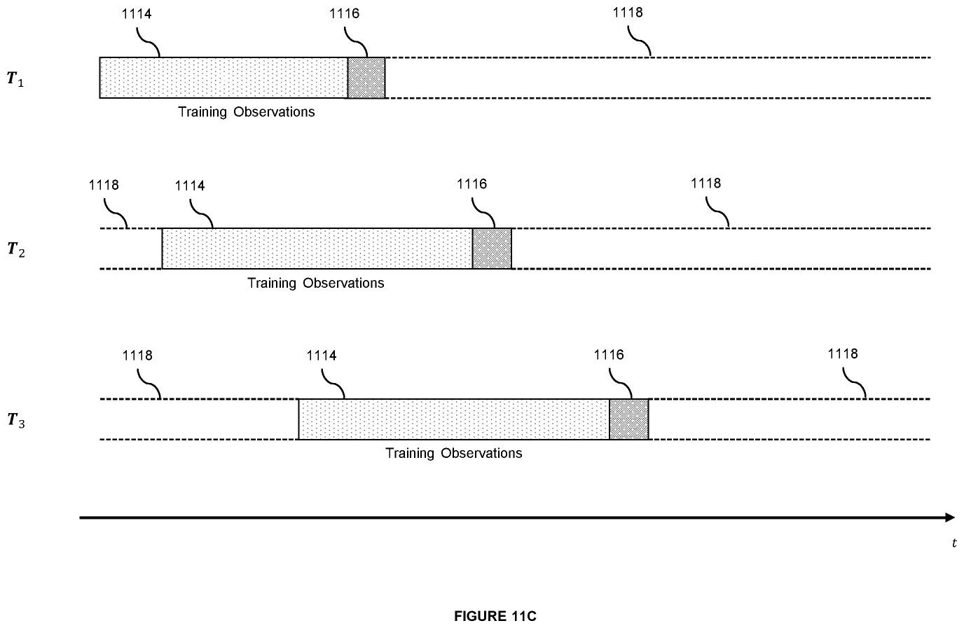

To help improve effective utilization of the observations within the training window, the number of observations upon which the predictor is trained may be dynamically adjusted as part of the training process. This is illustrated in FIGS. 11A-C.

FIG. 11A shows a fixed window approach to handling the number of observations to include when training a predictor.

FIG. 11A shows a training window comprising a plurality of training observations 1102 and one or more test observations 1104 which are part of a training window of a time-series signal 1106. FIG. 11A shows the change in the plurality of training observations 1102 and the one or more test observations 1104 across three iterations T₁, T₂, T₃ of a training process. A predictor is trained on the plurality of training observations 1102 to predict one or more observations corresponding to the one or more test observations 1104. The difference between the one or more predicted observations and the one or more test observations are used to determine the error rate of the predictor and are typically used to drive the training of the predictor.

At iteration T₁, the plurality of training observations 1102 has a first size (e.g., 50 time units encompassing 50 observations, or 100 time units encompassing 100 observations, etc.). According to the fixed window approach illustrated in FIG. 11A, the first size is used across all iterations such that at both iteration T₂ and iteration T₃ the size of the plurality of training observations 1102 remains constant (i.e., the size is equal to the first size).

FIG. 11B shows a rolling basis approach to handling the number of observations to include when training a predictor.

FIG. 11B shows a plurality of training observations 1108 and one or more test observations 1110 within a training window of a time-series signal 1112. As in FIG. 11A, three iterations T₁, T₂, T₃ of a training process are shown.

At iteration T₁, the plurality of training observations 1108 has a first size (e.g., 50 time units encompassing 50 observations, or 100 time units encompassing 100 observations, etc.). However, unlike the fixed window approach illustrated in FIG. 11A, at iteration T₂ the size of the plurality of training observations 1108 is increased by a predetermined amount (e.g., 1 time unit, or 5 time units, or 10 time units, etc.). Similarly, at iteration T₃ the size of the plurality of training observations 1108 is further increased by the predetermined amount such that the number of observations increases across subsequent iterations of the training process. This helps improve the accuracy and robustness of the predictor (such as the first predictor or the second predictor) over time.

FIG. 11C shows a rolling to fixed window approach to handling the number of observations to include when training a predictor.

FIG. 11C shows a plurality of training observations 1114 and one or more test observations 1116 within a training window of a time-series signal 1118. As in FIGS. 11A and 11B, three iterations T₁, T₂, T₃ of a training process are shown.

At iteration T₁, the plurality of training observations 1114 has a first size (e.g., 50 time units encompassing 50 observations, or 100 time units encompassing 100 observations, etc.). At iteration T₂, the size of the plurality of training observations 1114 is compared to a predetermined threshold (e.g., 100 time units or 100 observations, 200 time units or 200 observations, 500 time units or 500 observations, etc.). Because the size of the plurality of training observations 1114 is less than the predetermined threshold, the size of the plurality of training observations 1114 is increased by a predetermined amount (e.g., 1 time unit or 1 observation, 5 time units or 5 observations, 10 time units or 10 observations, etc.). At iteration T₃ the size of the plurality of training observations 1114 is again compared to the predetermined threshold. Because the size of the plurality of training observations 1114 is no longer less than the predetermined threshold, the size of the plurality of training observations 1114 remains unchanged. Consequently, the size of the plurality of training observations 1114 remains constant over subsequent iterations of the training process. This helps improve the accuracy and robustness of the predictor (such as the first predictor or the second predictor) over time.

The second predictor may be trained using the Adam optimizer. Alternatively, the second predictor may be trained using stochastic gradient descent.

Although the training process above is described in relation to the second predictor, the skilled person will appreciate that the process is equally applicable to training the first predictor.

Referring once again to FIG. 2, after the step of training 208 the second predictor, the method 200 optionally comprises the step of replacing 210 the outlier portion of the time-series signal with a predicted portion determined by the second predictor based on observations within the prediction window.

The outlier portion of the time-series signal is replaced with a predicted portion by obtaining predicted observations from the second predictor for each time point within the prediction window and replacing the observations within the time-series signal with the corresponding predicted observations. Alternatively, only a subset of observations within the prediction window are replaced with corresponding predicted observations. For example, only the observations known to correspond to the outlier portion are replaced by corresponding predicted observations.

The method 200 may then repeat such that the second predictor is used as the first predictor in a subsequent iteration of the method 200. In this way, anomaly detection may be applied to the entirety of a time-series signal. Optionally, once a time-series signal has been processed, the initial portion of the time-series signal corresponding to the first training window is processed for anomalies using one or more of the previously trained predictors.

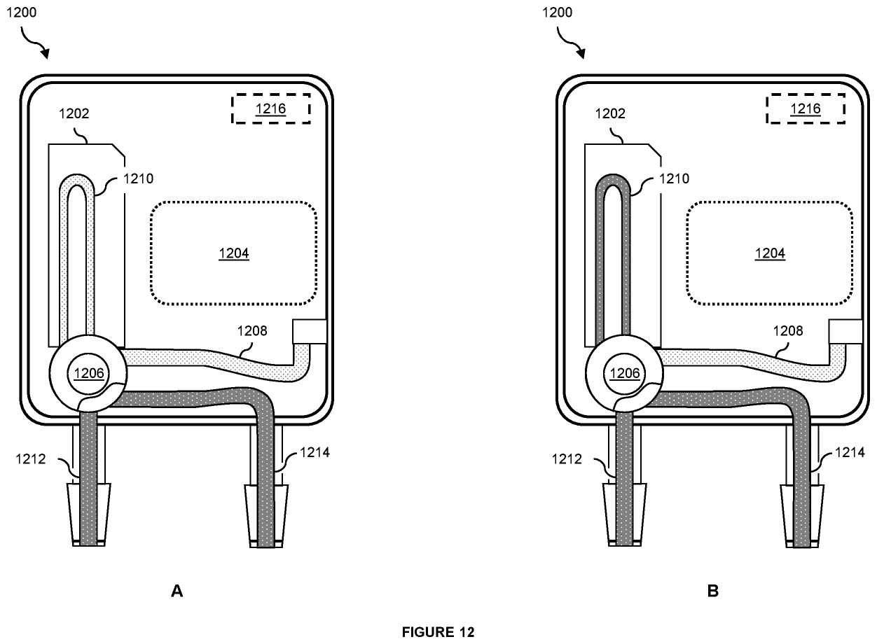

By using the method 200 to generate and train a predictor, and replace outlier portions of a time-series signal using the trained predictor, an improved time-series signal may be obtained. This improved signal may then be used to improve operation and control of one or more devices. Without accounting for and correcting anomalous regions in the above-described manner, the anomalous regions appear as false positive or false negative readings that may hinder operation of a device. For example, in some biomedical applications it is important to obtain a baseline reading of a sensor during a calibration phase to provide accurate comparisons with readings obtained during a measurement phase. However, anomalies appearing in the time-series signal during the calibration phase (e.g., due to bubbles being present within the calibration fluid) may lead to an incorrect or inaccurate baseline measurement being obtained thus resulting in inaccurate comparisons with readings obtained during the measurement phase. By identifying and removing such anomalies using the method 200, the device operates in an improved way by enabling improved accuracy of sensor readings during the measurement phase. This is illustrated by the device shown in FIGS. 12A and 12B below.

FIGS. 12A and 12B show a device 1200 (i.e. controllable system) comprising a sensor 1202, a reservoir 1204, and a valve 1206. A first fluid channel 1208 connects the reservoir 1204 and the valve 1206. A second fluid channel 1210 passes through and over the sensor 1202 from the valve 1206. A fluid inlet 1212 and a fluid outlet 1214 are both connected to the valve 1206. The device 1200 optionally comprises a control unit 1216.

The sensor 1202 is a polymer-based ion selective electrode (ISE). As is known, an ISE provides spot monitoring by converting the activity of an ion dissolved in a solution to electrical potential. ISEs are widely used within the fields of medicine, biology, and analytical chemistry. Typical applications include using an ISE in biomedical devices to measure the concentration of calcium, potassium, and sodium in bodily fluids such as blood, and using an ISE for pollution monitoring by measuring the concentration of fluorine, copernicium, etc. in water.

In use, the sensor 1202 is typically “flushed” with a calibration fluid before being exposed to an unknown fluid from which measurements are to be take. The calibration fluid flows from the reservoir 1204 through the first fluid channel 1208 to the valve 1206. The calibration fluid flows back to the reservoir 1204 through a further fluid channel. Alternatively, the calibration fluid flows back to the reservoir 1204 through the first fluid channel 1208. The unknown fluid flows from an external source (not shown) through the fluid inlet 1212 to the valve 1206 and from the valve 1206 through the fluid outlet 1214 to be further disposed of (e.g. flows to waste).

The valve 1206 is controlled by an external controller, such as the control unit 1216, or an external computing device. Configuration settings of the valve 1206 are adjusted by means of the external controller. Specifically, commands are sent to the device 1200 to control actuation of the value 1206.

In a first mode of operation (FIG. 12A), also referred to as a calibration phase, the valve 1206 is configured to allow the calibration fluid to flow from the reservoir 1204 through the first fluid channel 1208 to the second fluid channel 1210. The sensor 1202 then takes reference measurements from the calibration fluid flowing through the second fluid channel 1210.

In a second mode of operation (FIG. 12B), also referred to as a measurement phase, the valve 1206 is configured to allow the unknown fluid to flow from the external source (not shown) through the fluid inlet 1212 to the second fluid channel 1210. The sensor 1202 then takes measurements from the unknown fluid flowing through the second fluid channel 1210. The unknown fluid passes from the second fluid channel 1210 to the fluid outlet 1214 and out of the device 1200.

The sensor 1202 responds differently to the two fluids. The response of the sensor 1202 is measured as a voltage developed between the inside and the outside of the ion sensitive membrane of the sensor 1202. The time-series signal of the change in voltage received from the sensor 1202 over time will capture the transition of the sensor 1202 from measuring the calibration fluid to measuring the unknown fluid.

Bubbles within the fluid channels, particularly within the second fluid channel 1210, will lead to anomalous readings being recorded by the sensor 1202 (with bubbles appearing as sharp “spikes” within the time-series signal, such as the outlier portion 110 within the time-series signal 102 shown in FIG. 1). Such anomalies occurring during the calibration phase may lead to the device 1202 (specifically the sensor 1202) being incorrectly calibrated. For example, the sensitivity of the sensor 1202 may be increased or decreased by the external controller (e.g., the control device 1216) during the calibration phase as a result of anomalous readings being incorrectly identified as true readings. This results in inaccurate measurements being taken during the measurement phase thus inhibiting operation of the device 1200. In addition, such anomalies occurring during the measurement phase may lead to the device 1200 reporting inaccurate readings from the sensor 1202.

To address some, if not all, of these issues, the external controller, such as the control device 1216, employs the method 200 of FIG. 2 to identify and replace outlier portions (anomalies) during both the calibration phase and the measurement. By efficiently and accurately replacing anomalous readings, the external controller can improve calibration of the device 1200 and help obtain readings from the sensor 1202 which more accurately reflect the true measurements being taken. The method 200 of FIG. 2 may thus be used to improve the operation of devices such as the device 1200 of FIG. 12.

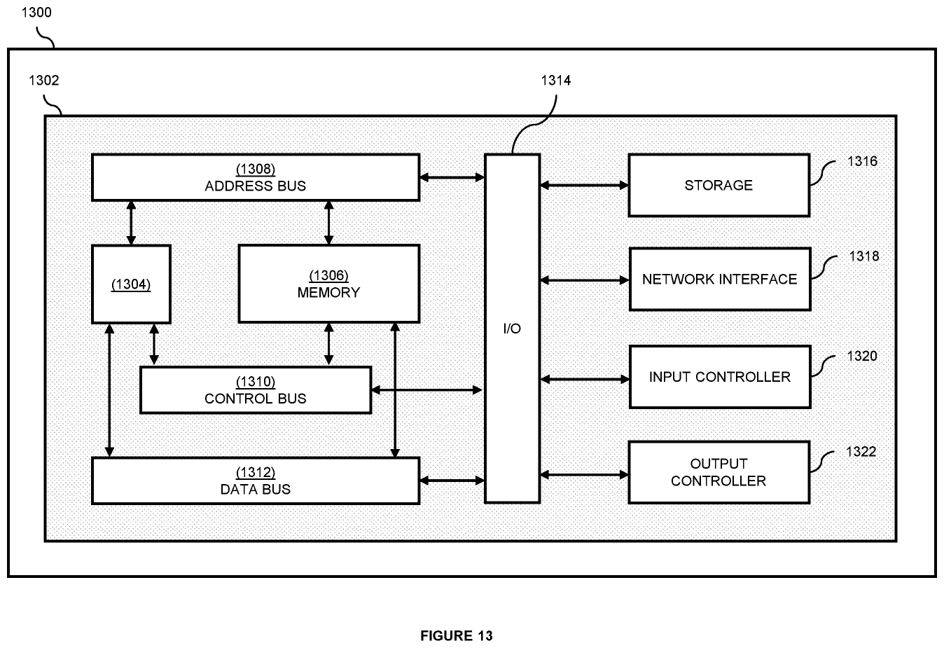

FIG. 13 shows an example computing system for time-series based anomaly detection. Specifically, FIG. 13 shows a block diagram of an embodiment of a computing system according to example aspects and embodiments of the present disclosure.

Computing system 1300 can be configured to perform any of the operations disclosed herein such as, for example, any of the operations discussed with reference to the method described in relation to FIGS. 2, 3, and 6. Computing system includes one or more computing device(s) 1302. One or more computing device(s) 1302 of computing system 1300 comprise one or more processors 1304 and memory 1306. One or more processors 1304 can be any general-purpose processor(s) configured to execute a set of instructions. For example, one or more processors 1304 can be one or more general-purpose processors, one or more field programmable gate array (FPGA), and/or one or more application specific integrated circuits (ASIC). In one embodiment, one or more processors 1304 include one processor. Alternatively, one or more processors 1304 include a plurality of processors that are operatively connected. One or more processors 1304 are communicatively coupled to memory 1306 via address bus 1308, control bus 1310, and data bus 1312. Memory 1306 can be a random-access memory (RAM), a read-only memory (ROM), a persistent storage device such as a hard drive, an erasable programmable read-only memory (EPROM), and/or the like. The one or more computing device(s) 1302 further comprise I/O interface 1314 communicatively coupled to address bus 1308, control bus 1310, and data bus 1312.

Memory 1306 can store information that can be accessed by one or more processors 1304. For instance, memory 1306 (e.g. one or more non-transitory computer-readable storage mediums, memory devices) can include computer-readable instructions (not shown) that can be executed by one or more processors 1304. The computer-readable instructions can be software written in any suitable programming language or can be implemented in hardware. Additionally, or alternatively, the computer-readable instructions can be executed in logically and/or virtually separate threads on one or more processors 1304. For example, memory 1306 can store instructions (not shown) that when executed by one or more processors 1304 cause one or more processors 1304 to perform operations such as any of the operations and functions for which computing system 1300 is configured, as described herein. In addition, or alternatively, memory 1306 can store data (not shown) that can be obtained, received, accessed, written, manipulated, created, and/or stored. In some implementations, the one or more computing device(s) 1302 can obtain from and/or store data in one or more memory device(s) that are remote from the computing system 1300.

Computing system 1300 further comprises storage unit 1316, network interface 1318, input controller 1320, and output controller 1322. Storage unit 1316, network interface 1318, input controller 1320, and output controller 1322 are communicatively coupled via I/O interface 1314.

Storage unit 1316 is a computer readable medium, preferably a non-transitory computer readable medium, comprising one or more programs, the one or more programs comprising instructions which when executed by one or more processors 1304 cause computing system 1300 to perform the method steps of the present disclosure. Alternatively, storage unit 1316 is a transitory computer readable medium. Storage unit 1316 can be a persistent storage device such as a hard drive, a cloud storage device, or any other appropriate storage device.

Network interface 1318 can be a Wi-Fi module, a network interface card, a Bluetooth module, and/or any other suitable wired or wireless communication device. In an embodiment, network interface 1318 is configured to connect to a network such as a local area network (LAN), or a wide area network (WAN), the Internet, or an intranet.

FIG. 13 illustrates one example computing system 1300 that can be used to implement the present disclosure. Other computing systems can be used as well. Computing tasks discussed herein as being performed at and/or by one or more functional unit(s) can instead be performed remote from the respective system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

1. A computer-implemented method for time-series based anomaly detection, the method comprising:
obtaining a first predictor trained on observations within a training window of a time-series signal, wherein the first predictor forecasts a predicted observation and a corresponding confidence value for a given time point;
estimating a confidence envelope for a prediction window of the time-series signal, wherein the confidence envelope comprises one or more confidence values estimated by the first predictor across the prediction window;
moving the training window and the prediction window according to an update process, wherein the update process comprises:
determining if an outlier portion exists within the prediction window of the time-series signal, the outlier portion comprising a contiguous plurality of observations of the time-series signal which lie outside the confidence envelope;
if the outlier portion is determined to exist within the prediction window:
determining a deviation point for the outlier portion, the deviation point being associated with a point in time at which the outlier portion begins; and
moving the training window such that the training window ends proximate the deviation point; and
training a second predictor on observations within the training window of the time-series signal that has been moved according to the update process.

2. The computer-implemented method of claim 1 further comprising:
replacing the outlier portion of the time-series signal with a predicted portion determined by the second predictor based on observations within the prediction window.

3. The computer-implemented method of claim 1 wherein the step of determining if the outlier portion exists within the prediction window comprises:
comparing the time-series signal to the confidence envelope;
wherein the outlier portion is determined to exist when a portion of the time-series signal within the prediction window lies outside the confidence envelope.

4. The computer-implemented method of claim 3 wherein the update process further comprises, if the outlier portion is determined to exist within the prediction window:
moving the prediction window such that the prediction window starts proximate the deviation point.

5. The computer-implemented method of claim 3 wherein the update process further comprises, if the outlier portion is determined not to exist within the prediction window:
incrementally moving the training window by a predetermined displacement amount.

6. The computer-implemented method of claim 5 wherein the update process further comprises, if the outlier portion is determined not to exist within the prediction window:
incrementally moving the prediction window by the predetermined displacement amount.

7. The computer-implemented method of claim 1 further comprising, prior to the step of training the second predictor:
increasing the training window size by a predetermined amount.

8. The computer-implemented method of claim 7 further comprising, prior to the step of training the second predictor:
comparing the training window size to a predetermined threshold; and
increasing the training window size by the predetermined amount when the training window size is less than the predetermined threshold.

9. The computer-implemented method of claim 1 wherein the confidence envelope is estimated from an error rate of the first predictor.

10. The computer-implemented method of claim 1 wherein the step of obtaining the first predictor comprises:
training the first predictor on observations within the training window of the time-series signal.

11. The computer-implemented method of claim 1 wherein the step of training the second predictor comprises:
retraining the first predictor on observations within the training window of the time-series signal that has been moved according to the update process.

12. The computer-implemented method of claim 1 wherein the first predictor and/or the second predictor comprise a deep learning model.

13. The computer-implemented method of claim 12 wherein the deep learning model comprises a convolutional neural network.

14. The computer-implemented method of claim 12 wherein the deep learning model comprises at least one dropout layer.

15. The computer-implemented method of any preceding claim 1 wherein the confidence envelope comprising a confidence band.

16. The computer-implemented method of claim 15 wherein the confidence band corresponds to a Bayesian approximation of uncertainty associated with predictions produced by the deep learning model based on observations within the prediction window.

17. The computer-implemented method of claim 1 wherein the confidence envelope comprises a confidence interval.

18. The computer-implemented method of claim 1 wherein determining the deviation point for the outlier portion comprises:
determining a transformed signal based on observations within the prediction window of the time-series signal, wherein the transformed signal is indicative of a rate of change of the time-series signal within the prediction window;
calculating a threshold based on a stationary portion of the transformed signal; and
identifying the deviation point within the first signal based on a point in time where the transformed signal crosses the threshold.

19. A computer-readable medium storing instructions which, when executed by one or more processors, cause the one or more processors to:
obtain a first predictor trained on observations within a training window of a time-series signal, wherein the first predictor forecasts a predicted observation and a corresponding confidence value for a given time point;
estimate a confidence envelope for a prediction window of the time-series signal, wherein the confidence envelope comprises one or more confidence values estimated by the first predictor across the prediction window;
move the training window and the prediction window according to an update process, wherein the update process comprises:
determine if an outlier portion exists within the prediction window of the time-series signal, the outlier portion comprising a contiguous plurality of observations of the time-series signal which lie outside the confidence envelope;
if the outlier portion is determined to exist within the prediction window:
determine a deviation point for the outlier portion, the deviation point being associated with a point in time at which the outlier portion begins; and
move the training window such that the training window ends proximate the deviation point; and
train a second predictor on observations within the training window of the time-series signal that has been moved according to the update process.

20. A device comprising:
one or more processors; and
a memory storing instructions which, when executed by the one or more processors, cause the one or more processors to:
obtain a first predictor trained on observations within a training window of a time-series signal, wherein the first predictor forecasts a predicted observation and a corresponding confidence value for a given time point;
estimate a confidence envelope for a prediction window of the time-series signal, wherein the confidence envelope comprises one or more confidence values estimated by the first predictor across the prediction window;
move the training window and the prediction window according to an update process, wherein the update process comprises:
determine if an outlier portion exists within the prediction window of the time-series signal, the outlier portion comprising a contiguous plurality of observations of the time-series signal which lie outside the confidence envelope;
if the outlier portion is determined to exist within the prediction window:
determine a deviation point for the outlier portion, the deviation point being associated with a point in time at which the outlier portion begins; and
move the training window such that the training window ends proximate the deviation point; and
train a second predictor on observations within the training.
